(19) United States
(12) Patent Application Publication
(10) Pub. No.: US 2024/0354800 A1
(43) Pub. Date: Oct. 24, 2024

(54) Efficient and Scalable Rewards Electronic System and Database

(71) Applicant: Max Travel, Inc., Los Angeles, CA (US)

(72) Inventors: David Keegan, Eagle, ID (US); David Packard, San Juan Capistrano, CA (US); Robert Frampton, Garner, NC (US)

(73) Assignee: MAX TRAVEL, INC., (omitted)

(21) Appl. No.: 18/617,470

(22) Filed: Mar. 26, 2024

Related U.S. Application Data
(60) Provisional application No. 63/460,108, filed on Apr. 18, 2023.

(51) Int. Cl. G06Q 30/0226

(52) U.S. Cl. CPC G06Q 30/0226; G06Q 2220/00

(57) ABSTRACT

System, methods and products for receiving an indication of a booking event completed by a user utilizing an application executed on a computing machine, the booking event being memorialized by way of storing a booking record in a booking database, the booking event being associated with a user's balance, the user's balance being represented by a number of points divisible into a first points portion and a second points portion. One or more electronic tokens are generated having a first value equal to a value of the first points portion, in response to a first threshold being met. The one or more electronic tokens are stored in an electronic ledger associated with the user. The user may be authorized to utilize the one or more electronic tokens on an electronic exchange platform to obtain one or more items or services. The second points portion are as credit on the user's balance. In one embodiment, the user is not authorized to use the credit to obtain items or services of value.

### CROSS REFERENCE TO RELATED APPLICATIONS

This application claims priority to the earlier filing date of U.S. Provisional Patent Application Ser. No. 63/460,108, filed on Apr. 18, 2023, the content of which is hereby incorporated by reference herein in its entirety.

### COPYRIGHT & TRADEMARK NOTICES

A portion of the disclosure of this patent document may contain material, which is subject to copyright protection. The applicant has no objection to the reproduction of the patent documents or the patent disclosure as it appears in the Patent and Trademark Office patent files or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material or features associated with such marks.

### TECHNICAL FIELD

The disclosed subject matter generally relates to electronic loyalty incentivization systems and databases and, more particularly, to an efficient and scalable electronic rewards point system, platform, or infrastructure.

### BACKGROUND

Reward point systems are commonly used by retailers, airlines, hotels, and other businesses to encourage user loyalty and repeat purchases. Depending on the rules of a rewards point system, users may earn points for their purchases and later redeem the points for various rewards. The rewards may be in the form of discounts, free products, or other perks. In addition, users may earn points by referring friends or participating in promotional activities, such as posting to social media, etc. Program points are typically accrued over time and may be redeemed unless the points have expired.

While a reward point system may be effective in encouraging user loyalty, some traditional reward programs have certain disadvantages. For example, implementing and maintaining an electronic reward system may be expensive for a small business, especially if the business offers valuable rewards. Further, reward programs may be complicated to set up and manage, especially if the business offers multiple rewards or has complex redemption rules. This complexity may frustrate users and make it difficult for them to understand how to earn and redeem rewards. Further, if the rewards offered are not competitive, the program may not be effective in incentivizing purchases.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, a computer-implemented system is provided for receiving an indication of a booking event completed by a user utilizing an application executed on a computing machine, the booking event being memorialized by way of storing a booking record in a booking database, the booking event being associated with a user's balance, the user's balance being represented by a number of points divisible into a first points portion and a second points portion. One or more electronic tokens are generated having a first value equal to a value of the first points portion, in response to a first threshold being met. The one or more electronic tokens are stored in an electronic ledger associated with the user. The user may be authorized to utilize the one or more electronic tokens on an electronic exchange platform to obtain one or more items or services. The second points portion are as credit on the user's balance. In one embodiment, the user is not authorized to use the credit to obtain items or services of value.

Implementations of the current subject matter may include, without limitation, systems and methods consistent with the above methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines may exchange data, commands or other instructions via one or more connections, including but not limited to a connection over a network.

The details of one or more variations of the subject matter described herein are set forth in the accompanying drawings and the description below. Other features and advantages of the subject matter described herein may be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIGS. 1 through 20 are provided, without limitation, as examples for different possible embodiments and features. As it is noted in further detail below, other embodiments, implementations, and features may be also available that are not fully disclosed or illustrated herein. Regardless, the scope of the subject matter disclosed should be deemed as encompassing all possible and alternative embodiments that have equal or equivalent functionality, as understood by one of ordinary skill in the related art and technology.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

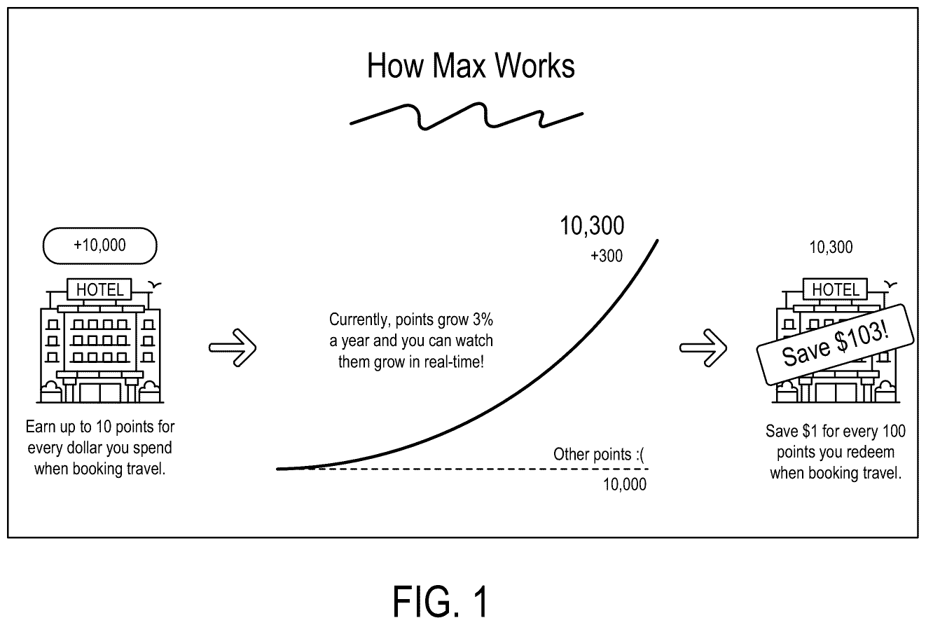

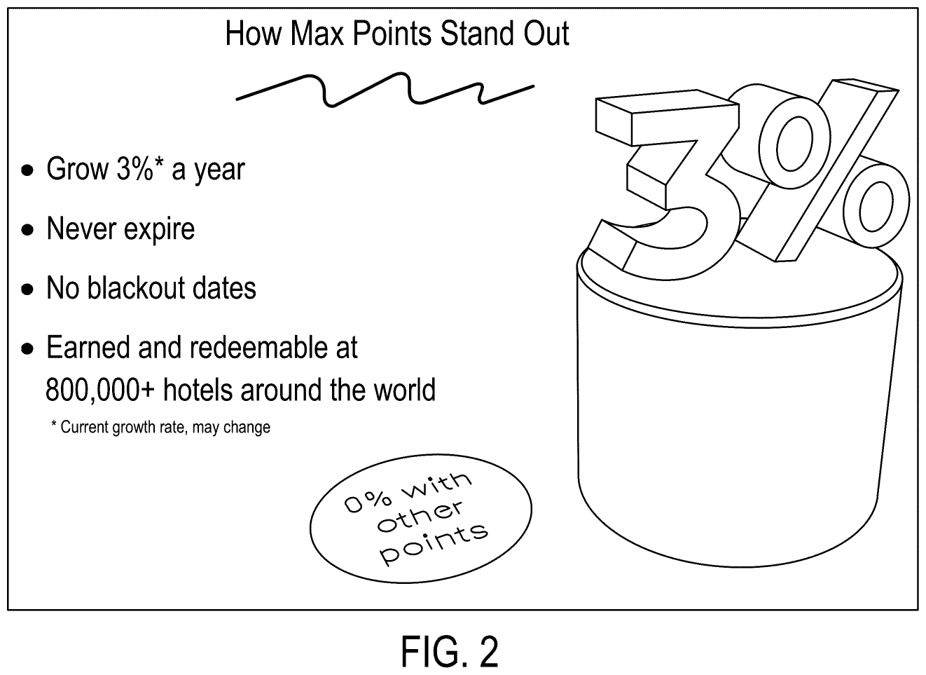

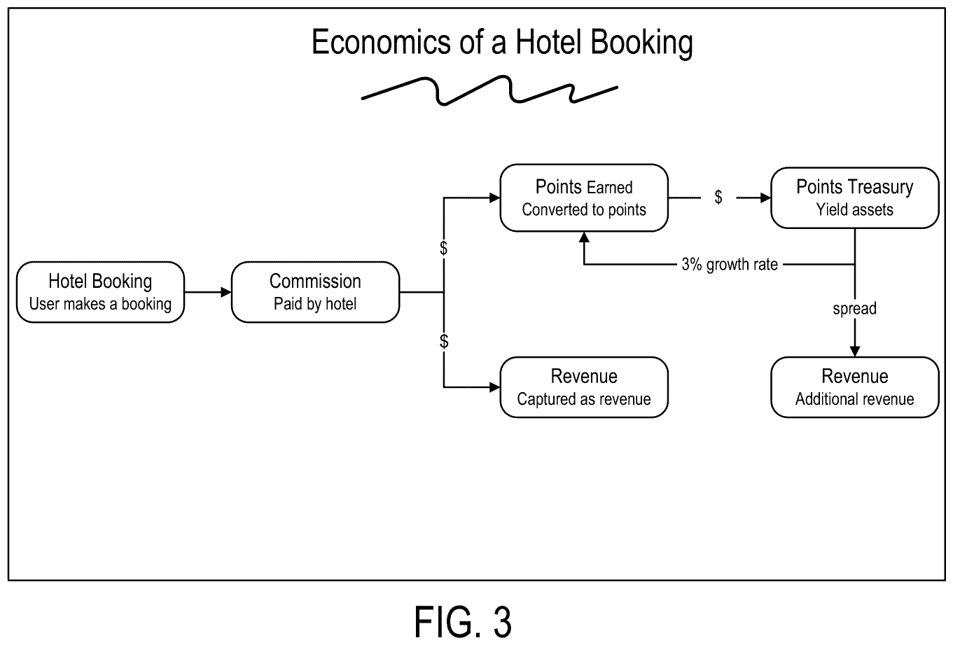

Referring to FIGS. 1 through 3, certain embodiments are implemented to allow certain individuals (e.g., travelers) to book events or travels and earn reward points that grow, for example, in a high yield savings account established for one or more reward points platforms. Depending on implementation, points earned may grow at the rate of 3% per annum and never expire. Users may view their points accumulating in real-time.

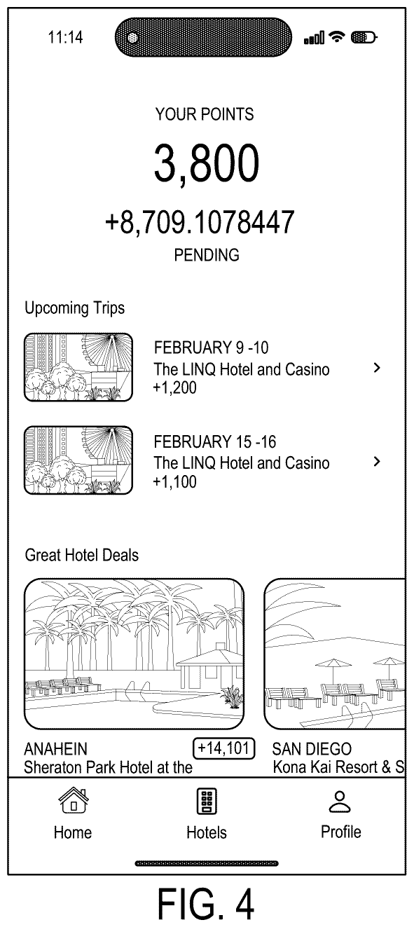

Referring to FIG. 4, point growth is based on (e.g., a previous day's) Earned Points balance (e.g., shown as 3800 in this example). On a monthly cadence, whole Growth Points may be converted into Earned Points. Any fractional Pending Growth Points may roll over to the next month. As illustrated in the example of FIG. 4, there are 8,700 Pending Booking Points and nine Pending Growth Points. The nine Pending Growth Points may become Earned Points within a month.

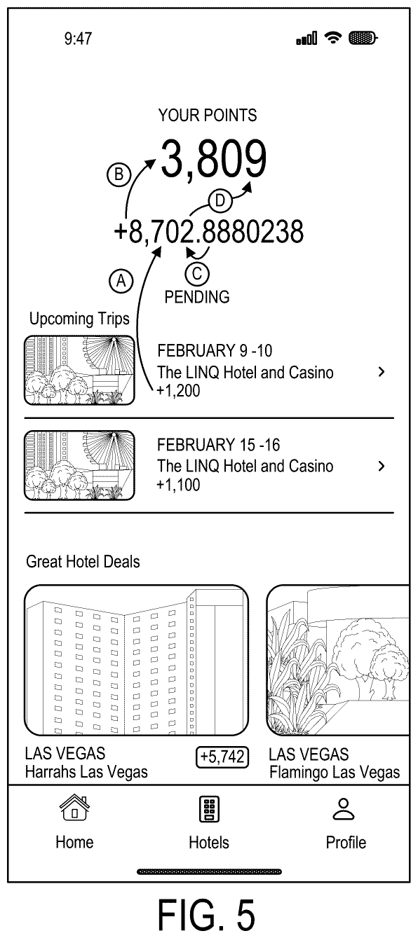

Referring to FIG. 5, Pending Points are earned through various activities (e.g., booking lodging, reserving air fare, automobile rentals, etc.). These points are pending until the criteria is met for them to become Earned Points. In this example, 8,700 Pending Points have accumulated from hotel bookings. In one embodiment, Pending Points become Earned Points when predetermined criteria are met. In one example scenario, the criteria are met 45 days after the booking has been completed. For Pending Growth Points the criteria management may be done on a monthly cadence. In illustrated example, 3,809 points have been earned in the account.

In some aspects, Pending Growth Points are displayed in real-time. As fractional Pending Growth Points become whole Pending Growth Points, the fractional points are added to the whole number of Pending Points. In the example of FIG. 5, two Pending Growth Points have accumulated for a particular month (e.g., February) and there are 0.8880238 fractional Pending Growth Points. On a monthly cadence, whole Pending Growth Points that have accumulated are converted into Earned Points. As shown, nine Pending Growth Points were earned the previous month, and two Pending Growth Points have accumulated for the month.

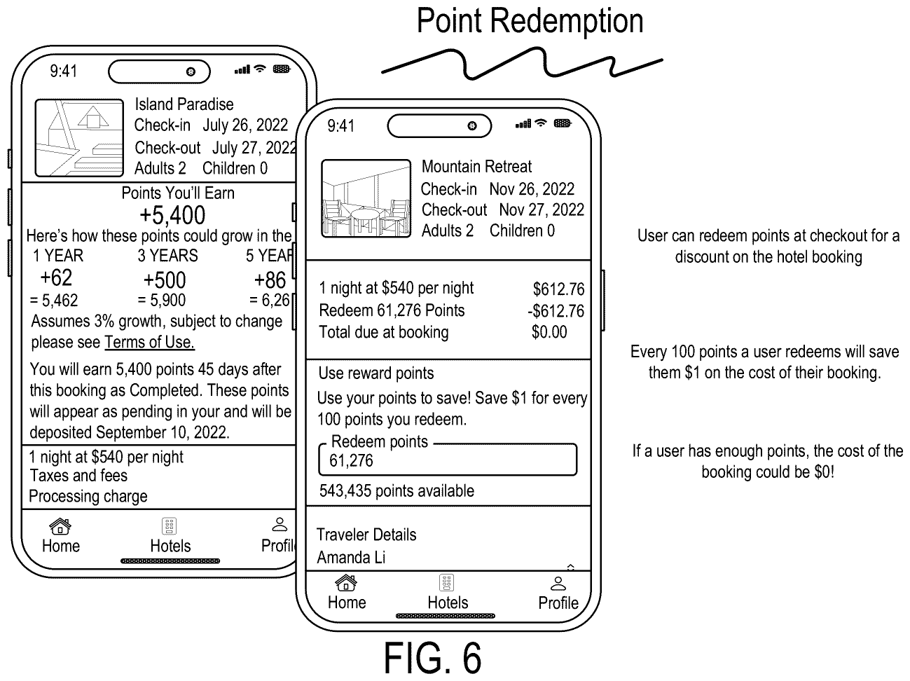

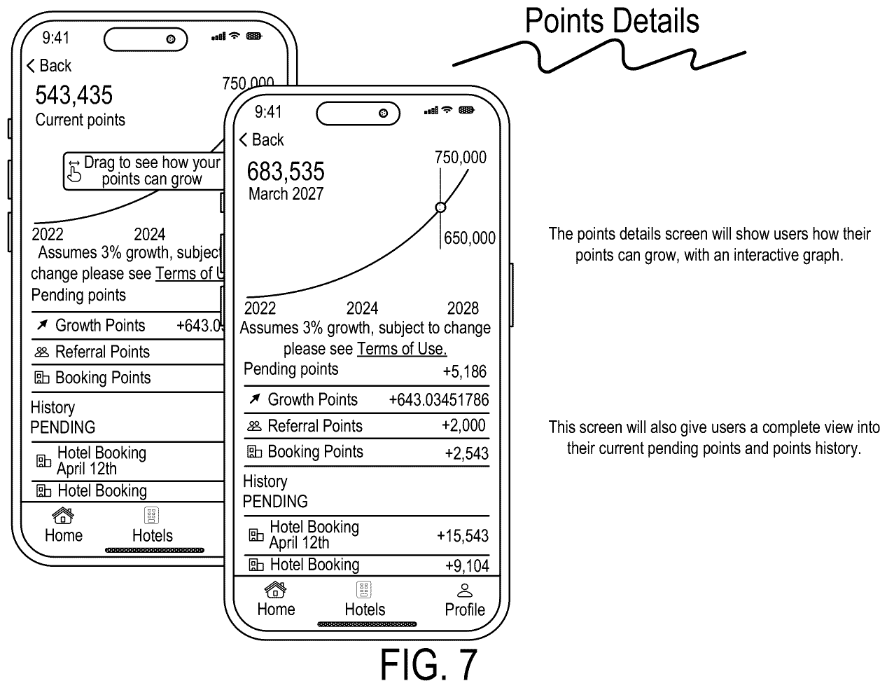

Referring to FIGS. 6 and 7, cash may be converted to points in certain implementations. By investing cash back rewards earned by users in high yield generating assets and investments, a system is established in which reward points may grow.

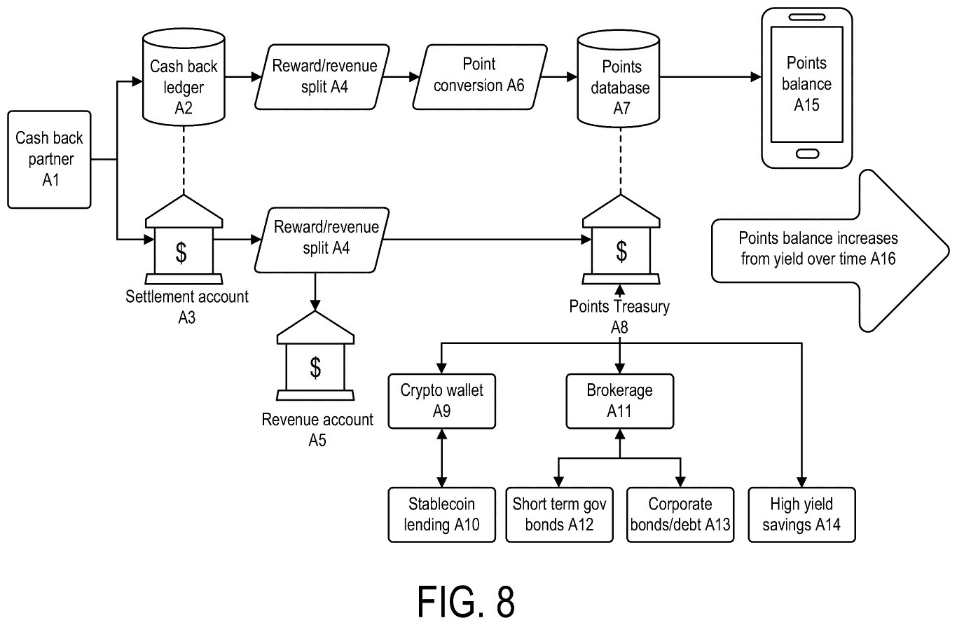

Referring to FIG. 8, cash back may come from a variety of sources and partners like travel booking commissions and shopping. The cash back partner A1 provides both a data feed of the transactions which are stored in a database ledger A2 as well as money deposited into a designated bank account A3. The cash back is then split between the users and the business based on rules determined by the business A4. The amount kept as revenue is transferred to a revenue bank account A5.

The amount given to users is converted to points at a predetermined conversion rate (e.g., 100 points may be deemed equal to $1 USD A6). The conversion results are recorded in the points database A7. The equivalent amount is transferred from the settlement account A3 to the points treasury A8. To achieve the yield to provide reward points that grow the money in the treasury A8 is transferred to several yield generating assets based on available yields and risk management, in accordance with one or more embodiments.

As an illustrative example, in one embodiment, a crypto wallet A9 may be used to earn lending yield on stablecoins such as USDC A10, this wallet may also be used for other crypto or DeFi yield strategies. A brokerage account A11 is used to invest money in assets like short term government bonds A12, corporate bonds or debt A13 or other assets. High yield savings accounts may also be used A14. All of these options may be used to achieve a blended growth rate for a given level of risk as determined by an administrative entity. Through the above strategies and investments, the assets in the points treasury account A8 may compound A16. The compounding may be reflected in the user's points balance, updated in real time A15.

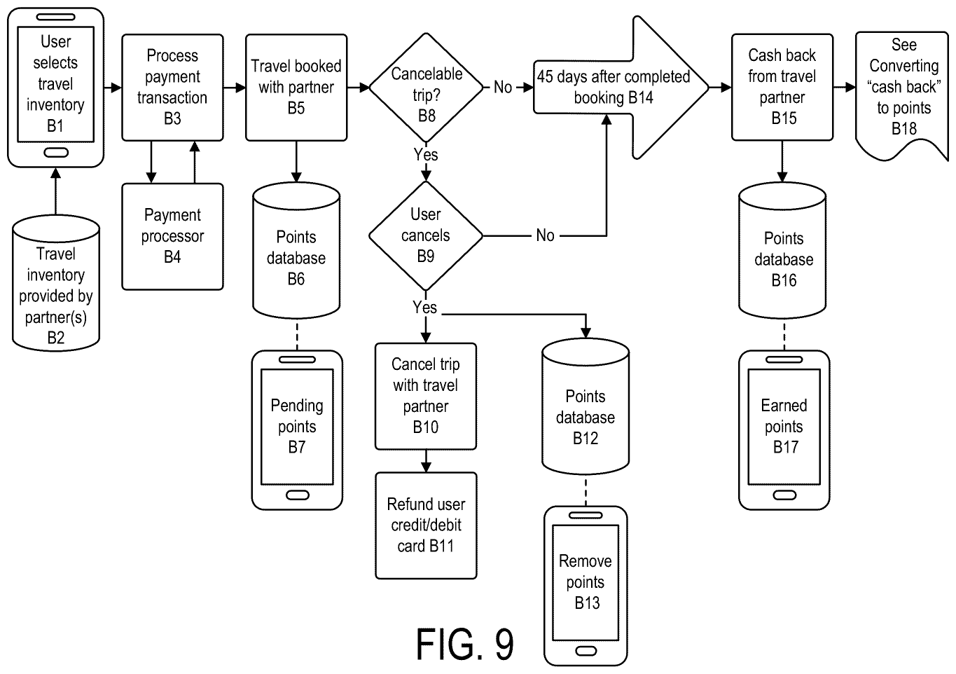

Referring to FIG. 9, users may earn points by way of different approaches as provided by a designated rewards plan. In one or more embodiments, users may browse and select travel options in an application or app B1, populated from the travel partner(s) B2. Once a user selects the travel they wish to book, they enter their booking and payment information B3 which is processed by a payment processing partner B4. Upon successful payment, the travel is booked with our travel partner B5. Once the travel partner confirms the successful booking, the points database is updated to reflect the pending points balance based on the commission that may be earned B6 and the business rules to split that commission between, for example, an administrative entity and the user. The pending points are then displayed to users within the app B7.

If the booking is cancelable B8 and the user chooses to cancel the booking B9, the trip may be canceled with the travel partner and a refund issued to the user B11. At the same time, the points database may be updated B12 and the pending points may be removed from display in the app B13. Certain number of days (e.g., 45 days) after the booking is completed B14, the travel partner may have deposited the commission into an account B15 (e.g., an administrative entity's settlement account) and the points database B16 and the app B17 may reflect the new earned points balance. This may kickoff the process described above to convert “cash back” to points.

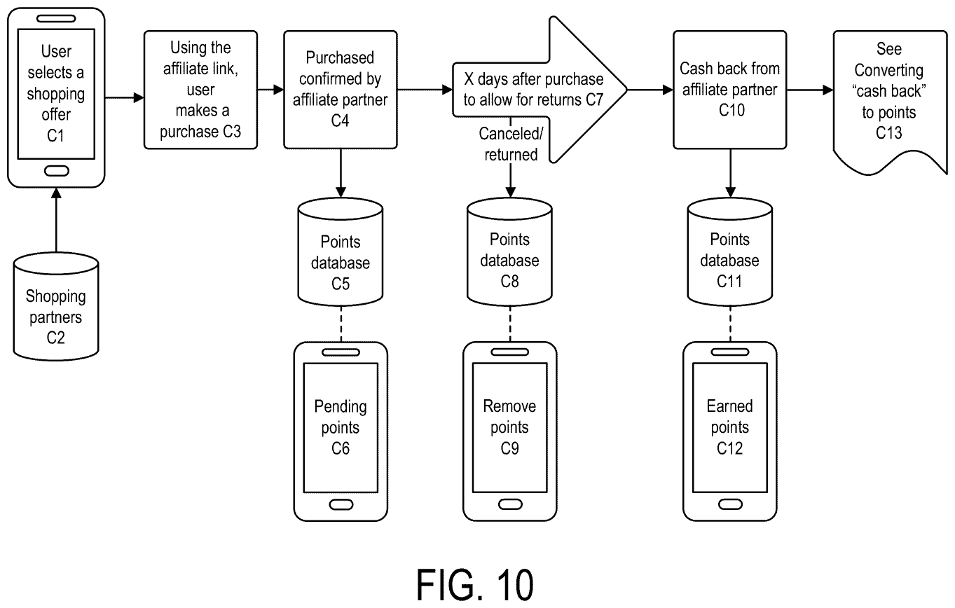

Referring to FIG. 10, an app may be implemented to have a shopping section where users may browse and search for shopping offers C1. This list may be populated by a backend database of all available offers and may be filtered or tailored to the specific user based on previous shopping history, favorites or other factors C2. When a user selects a shopping offer, they may be taking to that offer's partner app or website to complete the purchase C3. Once the purchase is made, the affiliate partner may then notify the user of the purchase and how much cash back the user is scheduled to earn C4. This amount is recorded in the Points database C5 and represented to the user within the app as pending points C6.

Based on the terms of a given affiliate partner, a user may be able to cancel or return a purchase within a certain period of time C7. If this occurs, the affiliate network may notify an administrative entity of the adjustment and the points database may be updated C8 and the points may be removed from the user's pending balance in the app C9. After the purchase has been confirmed by the affiliate partner, they may notify an administrative entity that the cash back has been confirmed C10. The points database may be updated to transition the points from a “pending” to “earned” status C11 and the points may also be displayed as earned in the App C12. The affiliate partner also transfers the cash back amount to the administrative entity, which may kick off the process described above to convert “cash back” to points D13.

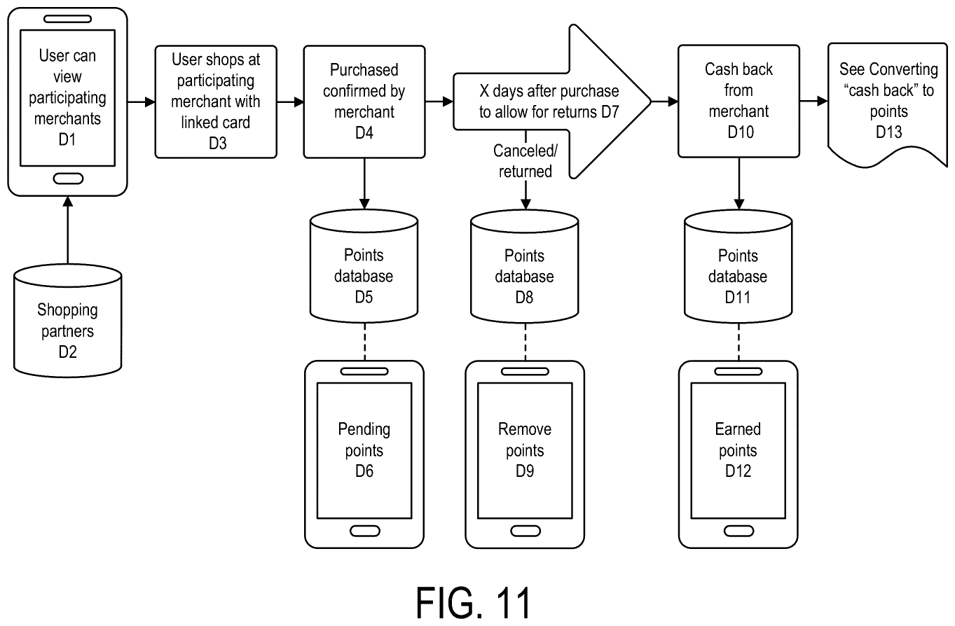

Referring to FIG. 11, in the shopping section of the app, users may browse and search for participating card linked merchants D1. This list may be populated by a backend database of all available offers and may be filtered or tailored to the specific user based on previous shopping history, favorites or other factors D2. If the user makes a purchase with a designated credit or debit card at a participating merchant D3, the partner may then notify the administrative entity of the purchase and how much cash back the user is scheduled to earn D4. This amount is recorded in the Points database D5 and represented to the user within the App as pending points D6.

Based on the terms of a given merchant, a user may be able to cancel or return a purchase within a certain period of time D7. If this occurs, the merchant may notify a designated entity of the adjustment and the points database may be updated D8 and the points may be removed from the user's pending balance in the app D9. After the purchase has been confirmed by the merchant, they may notify the administrative entity or other designated entity that the cash back has been confirmed D10. The points database may be updated to transition the points from a “pending” to “earned” status D11 and the points may also be displayed as earned in the app D12. The merchant also transfers the cash back amount to the administrative entity which may kick off the process described above to convert “cash back” to points D13.

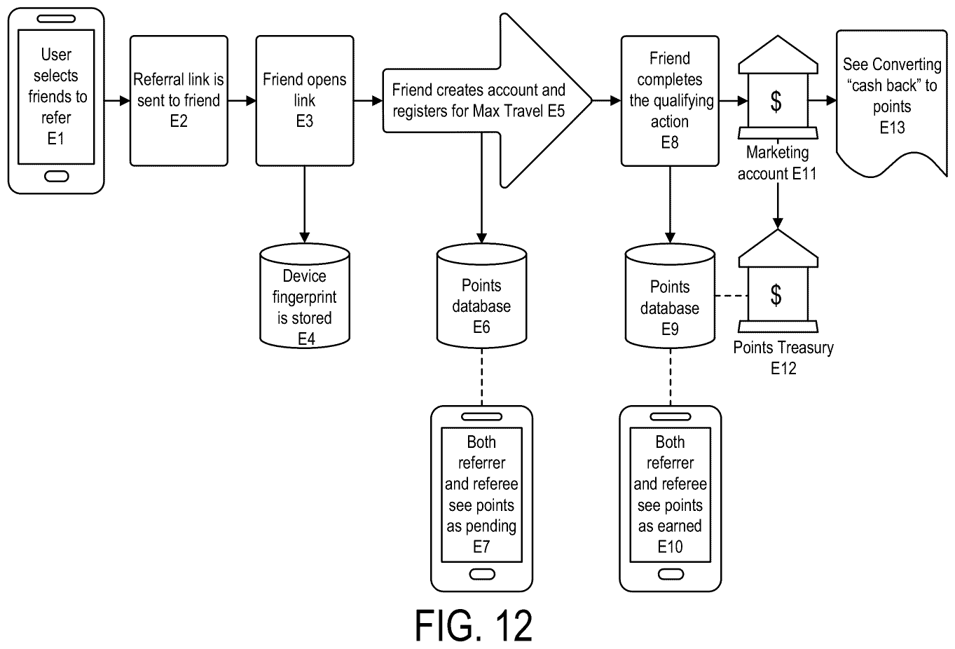

Referring to FIG. 12, a user may select friends to invite from within an app E1. This sends a unique referral link to each of the selected friends E2. The unique link may also be copied and shared in other forms, such as a social media post. When a friend opens the link E3, unique information (e.g., fingerprint) about their device may be stored E4. This allows for the device to be associated with the referral link for when the friend creates an account and registers for the rewards E5. When the friend completes account creation and registration, the bonus points may be recorded as pending for both the friend, and the user who referred them E6. They may see these points as pending in their app E7.

After the referred friend completes a qualifying action set by the administrative entity, such as a hotel stay, the bonus points from the referral may be updated in the database from “pending” to “earned” E9. This may be reflected in the app for both the friend, and the user who referred them E10. The money to back these points may be transferred from the Marketing budget account E11, to the points treasury B12. This may kickoff the process described above to convert “cash back” to points E13.

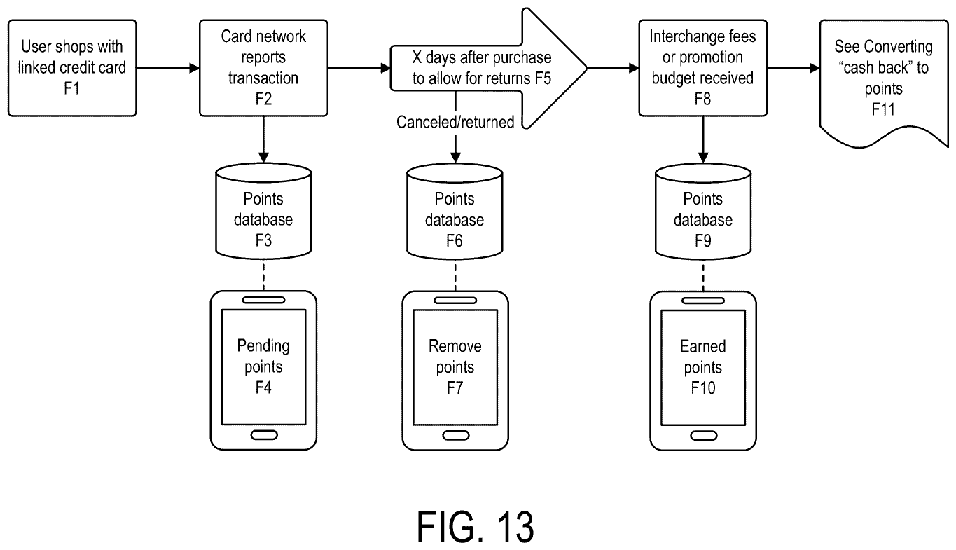

Referring to FIG. 13, if a user has a designated credit card, and uses it to make a purchase F1, a card network may report that purchase to a designated entity F2. Based on the purchase amount and point rules for a given category, the points database may be updated to reflect pending reward points for the transaction F3, these points may also be displayed to the user as pending in the App F4. Depending on the return policy of the merchant and credit card network, they may allow time for returns or cancellations F5. If a cancellation occurs, the credit card network may notify a designated entity and the points database may be updated to reflect the change F6, these points may also be removed from the app F7.

Once the credit card network or partner deposits the interchange fees collected, or marketing or promotional budget from the administrative entity is used F8, the points database may be updated to update the status of the points from “pending” to “earned” F9. This change may be reflected in the app F10. This may kick off the process described above to convert “cash back” to points F11, in accordance with one or more embodiments.

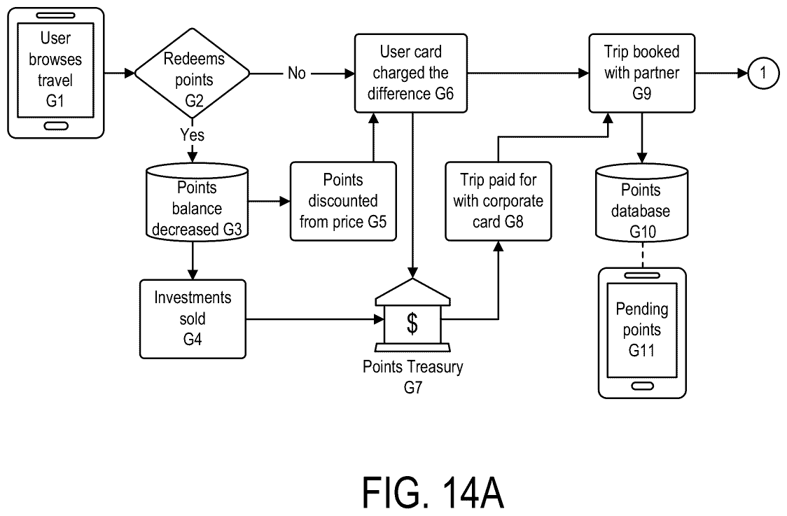

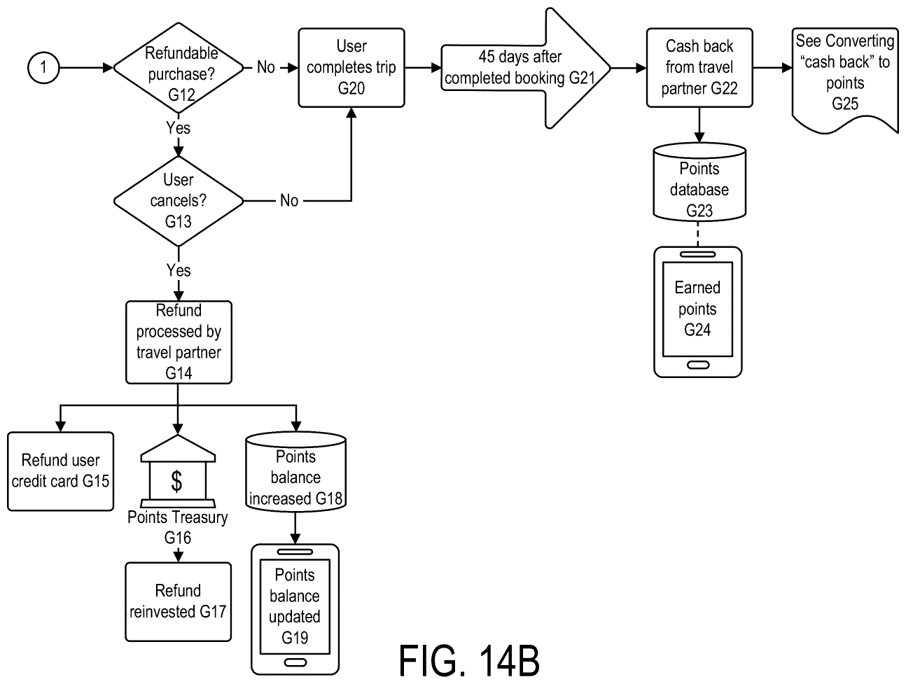

Referring to FIGS. 14A and 14B, users may be able to redeem their points for discounts on travel bookings, gift cards or cash. These sources may occur at different conversion rates, with a target of 100 points equaling $1 USD. In one example, when a user browses travel inventory in the app G1, during checkout they may choose to redeem points to reduce the cost of the booking by a conversion of 1 point equaling $0.01 USD G2.

If the user uses points when making the booking, their points balance may be decreased by the corresponding amount in the points database G3. The equivalent amount of investment holdings may be sold to cover the cost of the sold point G4. This amount may be transferred to the points treasury G7. The cost of the hotel may be discounted by the corresponding value of the points redeemed G5 and the user's payment method such as a debit or credit card may be charged for the remaining balance G6.

The full cost to book the travel may be paid with a corporate or virtual credit card sent to the travel partner G8. Upon successful processing of both the user's credit card and corporate/virtual credit card, the trip may be booked with the travel partner G9. The new booking may also accrue travel reward points which may be updated in the points database as pending G10 and users may be able to see these new points as pending in the App G11.

If the purchase is refundable G12, and the user chooses to refund their purchase G13. The travel partner may process the refund G14 and deposit the total cost of the trip back into the points treasury G16 and reinvested G17. At the same time, a refund may be issued to the user's payment method G15 and if any points were used for the booking, the points database may be increased by the amount of points used to book the refunded trip G18. The user may be able to see the increased points balance within the App G19.

Once the user completes their trip G20, the commission payment may be collected and transferred from the travel partner to a designated entity within 45 days of the completed booking G21. The travel partner may transfer the corresponding payment amount to a designated entity G22 and the corresponding points in the database may be changed from a status of “pending” to “earned” G23 and this may be reflected in the App G24. This may kick off the process described above to convert “cash back” to points G25.

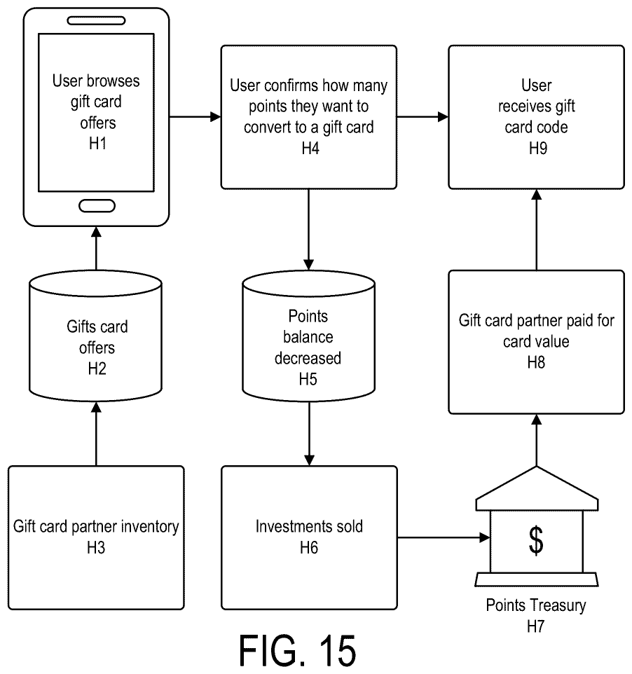

Referring to FIG. 15, a user may browse gift card redemptions offers within the App H1. These offers may be populated by a gift card offers database H2 and partner inventory H3. The user may then choose how many of their points they want to convert to a gift card balance H4. The amount they choose may be reduced from their points balance in the database H5. The corresponding amount of investments may be sold H6, transferred to the points treasury H7 and used to pay the gift card balance H8. The user may receive either a virtual gift card code, or physical gift card in the mail H9.

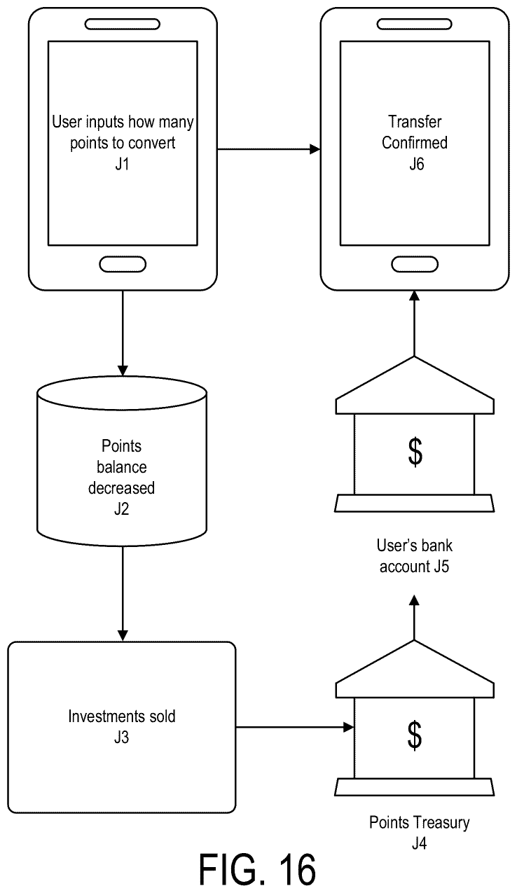

Referring to FIG. 16, a user may choose to redeem their points for cash at a conversion of 100 points equaling $1 USD from the App J1. When a user confirms the redemption, the points balance may be decreased in the database J2, investments sold J3 and transferred to the points treasury J4. Once settled, the money may then be transferred to the user's bank account J5 and the transfer may be confirmed to the user J6.

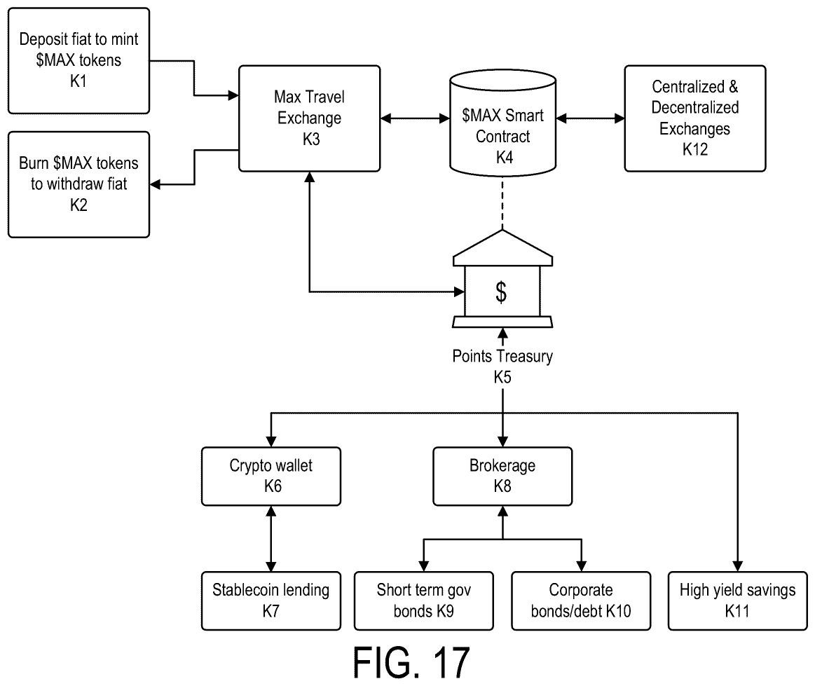

Referring to FIG. 17, a blockchain tokenization and stablecoin model may be implemented, in accordance with one or more embodiments. As shown, a centralized database solution may be provided to keep track of user's point balances. In some embodiments, a decentralized system of record may be implemented by creating a cryptocurrency token representing points. By utilizing blockchain technology, users are able to mint and burn a stablecoin representation of their points and then exchange and transact with these tokens just as they would any other blockchain token.

The token may be a centralized, points treasury backed, crypto currency token pegged to its US Dollar equivalent. This type of token is commonly referred to as a “stablecoin”. It may be made available on multiple blockchains. On Ethereum based blockchains, the token may conform to the ERC-20 protocol and a SPL token on the Solana blockchain, for example. A designated entity may create an exchange K3 where fiat currency may be converted into and out of the token. When fiat currency is deposited, new tokens may be created, this is commonly referred to as “minting” K1. When fiat currency is withdrawn, the corresponding amount of tokens may be removed from circulation, commonly referred to as “burning” K2.

Actions on a blockchain, such as minting and burning, may interact with the token smart contract K4. This serves as the public record, and “source of truth”, for the number of tokens in circulation. The fiat currency backing the token may be stored in a points treasury K5. To achieve the yield to provide “reward points that grow” the money in the treasury account K5 is transferred to several yield generating assets based on available yields and risk management determined by a designated entity. A crypto wallet K6 is used to earn lending yield K7, this wallet may also be used for other crypto or DeFi yield strategies. A brokerage account K8 is used to invest money in assets like short term government bonds K9, corporate bonds or debt K10 or other assets. High yield savings accounts may also be used K11. All of these options may be used to achieve a blended APY for a given level of risk as determined by a designated entity. Once the tokens have been added to a blockchain via the minting mechanism of the smart contract K4, these tokens may be used throughout the blockchain ecosystem just like any other ERC-20 or SPL token. For example, they may be exchanged for other tokens on centralized or decentralized exchanges K12.

The administrative entity may create a “Max Travel Token (MAX)” based on the Ethereum ERC-20 smart contract. The following code illustrates a cryptocurrency token designed to facilitate the use of reward points within the Ethereum blockchain ecosystem. This contract may adhere to the ERC-20 standard interface and includes all its customary functions. Uniquely, it may incorporate an annual growth component, which may be 3%, offering a novel approach to enhancing reward point value over time. One implementation may be crafted in Solidity, the programming language for developing Ethereum smart contracts, thereby integrating traditional reward systems with the innovative possibilities of blockchain technology.

```
pragma solidity \hat{ }0.8.0;
interface IERC20 {
  function totalSupply( ) external view returns (uint256);
  function balanceOf(address account) external view returns (uint256);
  function transfer(address recipient, uint256 amount) external returns (bool);
  function allowance(address owner, address spender) external view returns
(uint256);
  function approve(address spender, uint256 amount) external returns (bool);
  function transferFrom(address sender, address recipient, uint256 amount)
external returns (bool);
  event Transfer(address indexed from, address indexed to, uint256 value);
  event Approval(address indexed owner, address indexed spender, uint256 value);
}
contract MAXToken is IERC20 {
  string public constant name = “Max Travel Token”;
  string public constant symbol = “MAX”;
  uint8 public constant decimals = 18; // This is typical for ERC-20 tokens
  uint256 private _totalSupply;
  mapping(address => uint256) private _balances;
  mapping(address => mapping(address => uint256)) private _allowances;
  mapping(address => uint256) private _lastUpdate;
  uint256 public constant growthRate = 3; // 3% annual growth rate
  event GrowthApplied(address indexed to, uint256 value);
  constructor(uint256 initialSupply) {
    _totalSupply = initialSupply * 10**uint256(decimals);
    _balances[msg.sender] = _totalSupply;
    emit Transfer(address(0), msg.sender, _totalSupply);
  }
  function totalSupply( ) public view override returns (uint256) {
    return _totalSupply;
  }
  function balanceOf(address account) public view override returns (uint256) {
    if (_lastUpdate[account] == 0) return _balances[account];
    uint256 growthAmount = calculateGrowth(_balances[account],
_lastUpdate[account], block.timestamp);
    return _balances[account] + growthAmount;
  }
  function transfer(address recipient, uint256 amount) public override returns
(bool) {
    require(_balances[msg.sender] >= amount, “MAXToken: transfer amount
exceeds balance”);
    applyGrowth(msg.sender);
    applyGrowth(recipient);
    _balances[msg.sender] −= amount;
    _balances[recipient] += amount;
    emit Transfer(msg.sender, recipient, amount);
    return true;
  }
  function allowance(address owner, address spender) public view override
returns (uint256) {
    return _allowances[owner][spender];
  }
  function approve(address spender, uint256 amount) public override returns
(bool) {
    _allowances[msg.sender][spender] = amount;
    emit Approval(msg.sender, spender, amount);
    return true;
  }
  function transferFrom(address sender, address recipient, uint256 amount)
public override returns (bool) {
    require(_allowances[sender][msg.sender] >= amount, “MAXToken: transfer
amount exceeds allowance”);
    applyGrowth(sender);
    applyGrowth(recipient);
    _balances[sender] −= amount;
    _balances[recipient] += amount;
    _allowances[sender][msg.sender] −= amount;
    emit Transfer(sender, recipient, amount);
    return true;
  }
  function calculateGrowth(uint256 balance, uint256 lastUpdate, uint256
currentTime) public pure returns (uint256) {
    uint256 timeElapsed = currentTime − lastUpdate; // Time elapsed in seconds
    uint256 growthPerSecond = balance * growthRate / (365 * 24 * 60 * 60 *
100);
    return growthPerSecond * timeElapsed;
  }
  function applyGrowth(address account) public {
    if (_lastUpdate[account] != 0) {
      uint256 growthAmount = calculateGrowth(_balances[account],
_lastUpdate[account], block.timestamp);
      _balances[account] += growthAmount;
      _totalSupply += growthAmount; // Increase total supply by the growth
amount
      emit GrowthApplied(account, growthAmount);
    }
    _lastUpdate[account] = block.timestamp;
  }
}
```

### Travel NFTs

NFTs stand for “non-fungible token”, which in the context of crypto means that the token represents something specific and unique. On the Ethereum blockchain, the protocol for these types of tokens is defined by the ERC-721 Non-fungible Token Standard. As opposed to ERC-20 tokens where one ERC-20 token by design may be exchanged for any other, ERC-721 tokens have unique properties and attributes that make each token unique. This uniqueness may mean that ERC-721 tokens issued from the same project or smart contract may have wildly different value.

This technology may be used to encapsulate and memorialize anything that is unique. As it relates to travel and the platform, this could be a hotel stay, entire trip or experience. In one embodiment, NFT tokens may be issued that represent activities users do within the app. Examples of this would be a library of NFTs for hotel stay's people have completed, activities they have done or whole vacation packages and experiences they have booked.

In addition to being commemorative tokens of these experiences, the tokens may also be used to unlock additional functionality. The power of blockchain is that it is a public database and source of truth. So users could use their NFT library as a way to prove activities they have done and unlock additional benefits online, with retailers and in the real world. Accordingly, a token gated commerce may be provided where the tokens someone has in their crypto wallet unlock or gate some sort of custom or personalized experience. This could enable all sorts of new experiences, like special event access to users with certain tokens, free breakfast for users who have over a certain number of NFTs from a given hotel chain, or exclusive discounts based on the tokens in the user's wallet.

The administrative entity may, for example, create a “MaxTravelTrip (MTT)” Ethereum-based ERC-721 Non-Fungible Token (NFT). In addition to standard NFT features and functions, the MaxTravelTrip token may integrate additional, travel-specific attributes. This capability enables the creation and distribution of NFTs that not only represent ownership but also encapsulate unique properties for travel bookings and experiences. One implementation may be crafted in Solidity, the programming language for developing Ethereum smart contracts, thereby integrating traditional reward systems with the innovative possibilities of blockchain technology.

```
pragma solidity \hat{ }0.8.0;
import “@openzeppelin/contracts/token/ERC721/extensions/ERC721Enumerable.sol”;
import “@openzeppelin/contracts/access/Ownable.sol”;
import “@openzeppelin/contracts/utils/Counters.sol”;
import “@openzeppelin/contracts/utils/Strings.sol”;
contract MaxTravelNFT is ERC721Enumerable, Ownable {
  using Counters for Counters.Counter;
  using Strings for uint256;
  Counters.Counter private _tokenIds;
  string private _baseTokenURI;
  // New struct to hold travel-specific properties
  struct TravelDetails {
    string destination;
    string startDate;
    string endDate;
    string bookingReference;
  }
  // Mapping from token ID to TravelDetails
  mapping(uint256 => TravelDetails) private _travelDetails;
  constructor(string memory baseURI) ERC721(“MaxTravelTrip”, “MTT”) {
    setBaseURI(baseURI);
  }
  function setBaseURI(string memory baseURI) public onlyOwner {
    _baseTokenURI = baseURI;
  }
  function _baseURI( ) internal view override returns (string memory) {
    return _baseTokenURI;
  }
  // Updated mintNFT function to include travel details
  function mintNFT(
    address recipient,
    string memory destination,
    string memory startDate,
    string memory endDate,
    string memory bookingReference
  ) public onlyOwner returns (uint256) {
    _tokenIds.increment( );
    uint256 newItemId = _tokenIds.current( );
    _mint(recipient, newItemId);
    // Setting the travel details for the new item
    _travelDetails[newItemId] = TravelDetails(destination, startDate, endDate,
bookingReference);
    return newItemId;
  }
  // Function to get the travel details of a specific NFT
  function getTravelDetails(uint256 tokenId) public view returns (TravelDetails
memory) {
    require(_exists(tokenId), “Token ID does not exist”);
    return _travelDetails[tokenId];
  }
}
```

### Database Schema

In one embodiment, a single table design is implemented with an object storage database (e.g., DynamoDB). All entities leverage the same generic table properties. Relationships and additional properties are defined as TypeScript classes within the application logic. In addition to the class properties, every entity leverages the PK and SK DymamoDB attributes which act as a compound unique identifier per entity.

```
{
  “AttributeDefinitions”: [
    {
      “AttributeName”: “PK”,
      “AttributeType”: “S”
    },
    {
      “AttributeName”: “SK”,
      “AttributeType”: “S”
    },
    {
      “AttributeName”: “GSI1PK”,
      “AttributeType”: “S”
    },
    {
      “AttributeName”: “GSI1SK”,
      “AttributeType”: “S”
    },
    {
      “AttributeName”: “GSI2PK”,
      “AttributeType”: “S”
    },
    {
      “AttributeName”: “GSI2SK”,
      “AttributeType”: “S”
    }
  ],
  “ProvisionedThroughput”: {
    “WriteCapacityUnits”: 5,
    “ReadCapacityUnits”: 5
  },
  “TableName”: “max-travel”,
  “KeySchema”: [
    {
      “KeyType”: “HASH”,
      “AttributeName”: “PK”
    },
    {
      “KeyType”: “RANGE”,
      “AttributeName”: “SK”
    }
  ],
  “GlobalSecondaryIndexes”: [
    {
      “IndexName”: “GSI1”,
      “KeySchema”: [
        { “AttributeName”: “GSI1PK”, “KeyType”: “HASH” },
        { “AttributeName”: “GSI1SK”, “KeyType”: “RANGE” }
      ],
      “Projection”: {
        “ProjectionType”: “ALL”
      },
      “ProvisionedThroughput”: {
        “ReadCapacityUnits”: 1,
        “WriteCapacityUnits”: 1
      }
    },
    {
      “IndexName”: “GSI2”,
      “KeySchema”: [
        { “AttributeName”: “GSI2PK”, “KeyType”: “HASH” },
        { “AttributeName”: “GSI2SK”, “KeyType”: “RANGE” }
      ],
      “Projection”: {
        “ProjectionType”: “ALL”
      },
      “ProvisionedThroughput”: {
        “ReadCapacityUnits”: 1,
        “WriteCapacityUnits”: 1
      ]
    }
  ]
}
```

Below are the example domain entities that leverage the previously documented DynamoDB table. An entity may leverage the PK and SK attributes of the DynamoDB table. The values for these attributes are string values that inject entity property values into a template that help differentiate the entities from one another in the single table design. The format for each entity's PK and SK values are documented below.

The User entity represents an end user:

```
  class User {
    id: string;
    name?: string;
    email?: string;
    emailVerified: boolean;
    firebaseId: string;
    createdAt: Date;
    updatedAt: Date;
  }
Primary Key (PK attribute) format: USER#{id}
Sort Key (SK attribute) format: USER#{id}
```

The Balance entity contains the aggregated points values of all Transaction entities for a given user. It may be described as the current state of the points ledger, and may be recalculated by reducing all Transaction entities for a given user.

When a new Transaction entity is added for a User. The Balance entity is recalculated.

```
  class Balance {
    id: string;
    userId: string;
    amount: number;
    pendingAmount: number;
    createdAt: Date;
    updatedAt: Date;
  }
Primary Key (PK attribute) format: USER#{userId}
Sort Key (SK attribute) format: BALANCE
```

A Transaction entity is a ledger entry concerning the points balance of a given user. Transactions may represent pending points being added, pending points being removed (canceled), pending points being earned, earned points compounding via growth, and earned points being withdrawn for booking additional trips and other forms of redemption.

```
    export type TransactionType =
      | ‘deposit’
      | ‘withdrawal’
      | ‘compound’
      | ‘pendingClear’
      | ‘pendingDeposit’
      | ‘pendingWithdrawal’;
  class Transaction {
      id: string;
      userId: string;
      amount: number;
      description: string;
      type: TransactionType;
      bookingId?: string;
      createdAt: Date;
  }
Primary Key (PK attribute) format: USER#{userId}
Sort Key (SK attribute) format: TRANSACTION#{id}
```

The definition of how interest is calculated is outlined below with reference to an example code:

```
import { startOfDay } from ‘date-fns’;
export const DAILY_GROWTH = 0.00008213552361396303;
export const calculateGrowthByDay = (
  amount: number,
  date = startOfDay(new Date( )),
) => amount * DAILY_GROWTH * (date.getDate( ) − 1);
const calculatedAt = startOfDay(new Date( ));
const points = await
this.pointsService.findBalanceOrThrow(user.id);
const growth = calculateGrowthByDay(points.amount,
calculatedAt);
return {
  dailyGrowth: DAILY_GROWTH,
  currentBalance: points.amount,
  pendingBalances: {
    bookings: points.pendingAmount,
    referrals: 0,
    growth: growth,
    calculatedAt,
  },
};
```

### Point System Periodicity & Complexities

In one or more embodiments, the reward points system contains unique and novel complexities not exhibited in traditional systems in order to enable “reward points that grow”. Points may be earned at multiple periodicities. For example, users earn Booking Points from booking travel on the platform, 45 days after a completed travel experience, whereas Growth Points are earned monthly, based on the users Earned Points balance. See below for more details.

Pending Points Vs. Earned Points

There may be three kinds of loyalty reward points in the Loyalty Program: Booking Points, Growth Points, and Earned Points. Booking Points, Growth Points, and Earned Points are not the same and have important differences. Herein, we refer to Booking Points and Growth Points collectively as “Pending Points.” Pending Points are not redeemable unless and until they become Earned Points.

### Booking Points

Each time a user books a travel experience through the Platform, they may earn points that are not yet redeemable (“Booking Points”). Pending Points, including Booking Points, are not redeemable unless and until they become Earned Points. Booking Points convert into Earned Points that may be redeemed for additional travel experiences.

The number of Booking Points earned for each dollar spent booking travel experiences through the platform varies from experience to experience. Before a user clicks to confirm a purchase to book a travel experience through the platform, the purchase page may display the number of Booking Points they may receive when they click to confirm.

### Growth Points

Growth points are calculated and accrued to a user's account as additional points for periods during which they wait to redeem Earned Points. Pending Points, including Growth Points, are not redeemable unless and until they become Earned Points. Growth Points convert into Earned Points as a way for rewarding continued loyalty.

For example, Growth Points may be accumulated in a user's account each day at the rate of 3% per year of the user's balance of Earned Points at the end of the previous day. The rate at which Growth Points accumulate may change at any time, or end, at any time in the administrative entity's sole discretion. Growth Points are not accumulated for the user's balances of Waitlist Points, Booking Points or Growth Points. Rather, Growth Points may accumulate only for the user's balance of Earned Points.

### Earned Points

The Pending Points received when booking a travel experience through the platform become Earned Points on the first business day after the passage of a predetermined number of days (e.g., 45 calendar days) from when the user completed the travel experience and checks out of the hotel or other property where they stayed. If the user receives Pending Points for a refundable travel experience and canceled that travel experience, the Pending Points may be canceled. Pending Points that are canceled do not become Earned Points.

In one implementation, Growth Points may convert into Earned Points within one month of the Growth Points' accrual. The administrative entity determines whether to convert Growth Points into Earned Points and, if so, when to convert them in the administrative entity's sole and absolute discretion.

Although the user's account may accumulate fractions of Growth Points, only whole Growth Points may convert to Earned Points. So, for example, if a user's account has accumulated 100.6789 Growth Points at the time when they may be converted into Earned Points, only the 100 Growth Points may be converted into Earned Points. The residual 0.6789 Growth Points may remain in the user's account and combine with additional Growth Points they accumulate in the future.

The administrative entity may cancel a user's Earned Points at any time if they suspect in its sole and absolute discretion that the user has engaged in or aided fraud or other misconduct, including without limitation any breach of the Terms of Use, misconduct or inappropriate activity relating to the platform. Users may redeem Earned Points as a discount on the price of a travel experience equivalent to $0.01 USD for every Earned Point redeemed.

### Sort & Primary Keys

The primary DynamoDB datastore leverages a Single Table Design. This allows for storing all relational data in a single NoSQL database table that is read-optimized and highly scalable. Items located in the table have a Primary Key (PK) that is populated by the user's unique identifier. The Sort Key (SK) is then used to differentiate between various entities that belong to the user (Bookings, Transactions, etc.). In other words, it is possible to quickly and efficiently look up all data belonging to a given user unlike a traditional SQL based relational database in which such lookups are typically expensive and considered bad practice.

A benefit of the above design is scalability. The platform is able to incur millions of users without major performance concerns. Following is an example of the PK and SK for a Transaction entity that is part of the points ledger system.
PK: USER#2JefF8CoZWClzw6n0uPd2KhCMdV
SK: TRANSACTION#2JefJEUrJMGEyZkIFXxKtyig6Xw

The unique identifiers are KSUIDs, which are universally unique identifiers similar to UUIDs with the added benefit of being lexically sortable.

### Point Ledger System

The points ledger system contains an immutable history of all point transactions. When a new transaction is added for a given user, the current balance of the user is calculated by adding all existing transaction amounts for the user. This current balance is then cached so that one may quickly look up the balance for a given user without having to recalculate all past transactions in the ledger.

Ledger entries may represent pending points or cleared points. Pending points are added when a booking has been made. The points may remain as pending until the booking has been completed at which point the pending points may be cleared. The total number of pending points and total number of cleared points are cached as separate values. Earned points may be used as payment for future bookings while pending points cannot.

Each ledger entry may include a single type field which represents what kind of points the transaction is concerning (pending or cleared), and where the points may be moved to (deposited, withdrawn, or cleared). The following are descriptions of possible ledger entry types.
deposit: when earned points are given directly to a user, such as promotional points for new user signups
withdrawal: when earned points are redeemed for a new booking
interest: when whole pending points are converted to earned points within a month
pendingClear: when pending booking points are converted to earned points
pendingDeposit: when pending points are added from a new booking
pendingWithdrawal: when pending points are removed from a canceled booking

At any point if there is a dispute concerning the current balances of pending or cleared points, the balance may be recalculated from the ledger entries.

### Growth Calculations Accuracy

Further protection against errant balances includes explicit tracking of when a user's whole pending growth points were last converted to earned points. This allows for calculating how many pending points a user has accrued through growth down to the second. This is possible as the point ledger system stores a unique timestamp for when a user's whole pending growth points were last converted to earned points. The timestamp may be also leveraged when the mobile application displays a user's current pending growth points. This ensures that the pending growth points visible in the application are always derived from when the user last earned pending growth points, rather than inferring a value based on the current date/time.

### Pending to Earned Point Conversion Failure

If a software or networking issue occurs when a user's pending points are being converted to earned points, the process may automatically be retried until it is successful. Since the mobile application leverages the user's conversion timestamp for calculating their pending growth points, delays may not affect the accuracy of the displayed pending growth points.

### Fractional Growth Rollover

When it comes time for a user's pending growth points to be converted to earned points, a designated entity may deposit whole point values, such that any decimal values won't be applied to a user's balance. However, instead of simply rounding the value, the remainder is stored in the points ledger and reapplied at the next month's conversion date. This remainder is also taken into account when displaying pending growth to end users within the application ensuring an accurate representation of how many points may be earned at the start of the month.

If it comes time to convert a user's accrued growth points but the user has accrued less than one whole point, the fractional value is persisted, and the timestamp of when the user's last conversion remains the same. This again helps ensure an accurate depiction of pending growth points within the application. This cycle may repeat itself until a conversion date is reached where at least one whole point has been accrued, at which point the whole pending growth points will become earned points, and the conversion timestamp is updated.

### Options for Users to Earn Points

Commission or promotions when booking any form of travel: hotels, rental cars, activities, cruises, trains, boats, buses, flights, hostels, homestays, bed and breakfast, camping.
Commission or promotions when shopping: in store, online, through affiliate links, on linked cards, on a credit card, with credit, with debit, by scanning receipts, with coupons.
Transferring other points or miles to the reward program
Purchasing reward points with money, credit, gift cards or crypto currency
Be given reward points by other brands
Interchange or promotions when using a designated credit card, or linked, credit/debit card
Completing surveys and market research.
Interacting with the platform or other brands on social media. Following, liking, commenting or posting
Incentives in fitness and wellness programs
As a referral program promotion. Users may earn points when they refer a friend to the rewards program, and the person being referred could earn points too
Sweepstakes-users may earn bonus points as part of a sweepstakes
No-lose-lottery-user may earn bonus points as part of a “no-lose-lottery” style promotion
Users may earn points for performing actions like leaving a review in the App Store or Play Store, or for leaving reviews on hotels and other travel activities or shopping.
Users may earn points by sharing their trip recommendations or itinerary with other users who book travel from their recommendation.
Gambling and games of chance where users may play for a chance to earn points.
Games of skill where users may play to earn more points.

### Ways Users May Redeem Points

Discount when booking any form of travel: hotels, rental cars, activities, cruises, trains, boats, buses, flights, hostels, homestays, bed and breakfast, camping.
Discount when shopping: in store, online, through affiliate links, on linked cards, on a credit card, with credit, with debit, by scanning receipts, with coupons.
Redeeming reward points for other points or miles
Redeeming reward points for money, gift cards, crypto currency, discounts, coupons, credits in other services
Statement credits or to pay off credit card balances
Merchandise from a designated brand or other brands
Charitable donations with or without a tax write-off
Experiences such as concert tickets, sporting events, or wine tastings, movie premiers, cooking classes, special events or dining.
Travel upgrade or additional benefit. Like an upgrade to first class, or airport lounge access.
Users could redeem points for raffle tickets to win prizes in sweepstakes, lotteries or other similar promotions.
   Investments that May Power the Point Growth

| | |
|---|---|
| High-yield savings accounts | Corporate bonds |
| Corporate debt | Foreign bonds |
| Foreign debt | Municipal bonds |
| Floating rate bonds | High-yield bonds |
| US Treasury bonds | US Treasury notes |
| Corporate bond funds | Treasury bond funds |
| Floating rate bond funds | International bonds |
| Government bonds | Municipal bond funds |
| Mutual funds | Hedge funds |
| Venture investing | Dividend stocks |
| Index funds | Individual stocks |
| Options | Peer-to-peer lending |
| Dividend-paying mutual funds | Money market funds |
| Commercial Real Estate | Residential Real Estate |
| Rental properties | Certificates of Deposit (CDs) |
| Crypto Investing | Bitcoin |
| Ethereum | Crypto staking |
| Crypto lending | Stablecoin lending |
| Issuing a crypto token | DeFi (Distributed Finance) |
| Alternative assets like art, wine, | Real Estate funds |
| watches . . . | |
| Real Estate Investment Trusts | Sovereign Wealth |
| (REITs) | |
| Loans | Debt |
| High-yield bond funds | International bond funds |
| Government bond funds | Commodities |
| Real estate crowdfunding | Agricultural commodities |
| Energy commodities | Precious metals |
| Industrial commodities | Equity-income funds |
| Income-oriented exchange-traded | Balanced funds |
| funds (ETFs) | |
| Multi-asset funds | Target-date funds |
| Annuities | Alternative investments |
| Hedge funds | Private equity funds |
| Venture capital funds | Impact investing |
| Social impact bonds | Green bonds |
| Property funds | Infrastructure funds |
| Gold mining stocks | Preferred stock |
| Master limited partnerships | Exchange-traded notes (ETNs) |
| (MLPs) | |
| Equity-linked notes (ELNs) | Exchange-traded funds (ETFs) |
| A diversified portfolio of all or any | |
| of the above | |

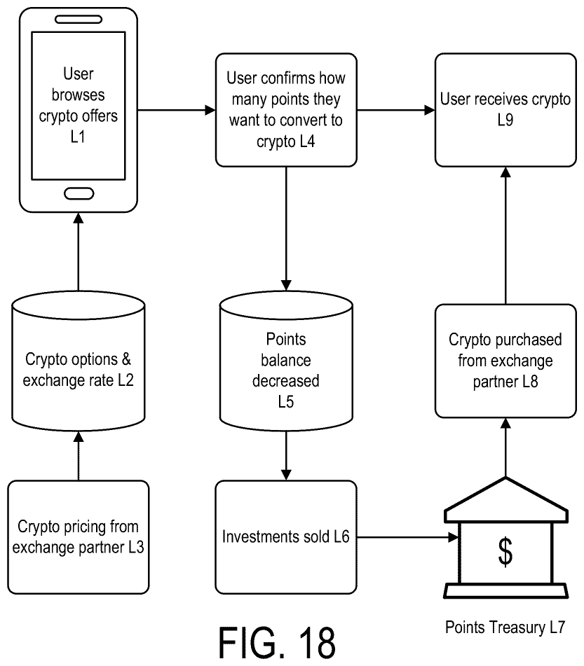

Referring to FIG. 18, a user may browse crypto currency redemption offers within the App L1. These offers may be populated by crypto offers database L2 and partner exchange L3. The user may then choose how many of their points they want to convert to crypto currency LA. The amount they choose may be reduced from their points balance in the database L5. The corresponding amount of investments may be sold L6, transferred to the points treasury L7 and used to pay for the crypto currency L8. The user may receive their cryptocurrency in a custodial wallet or self-custody wallet L9.

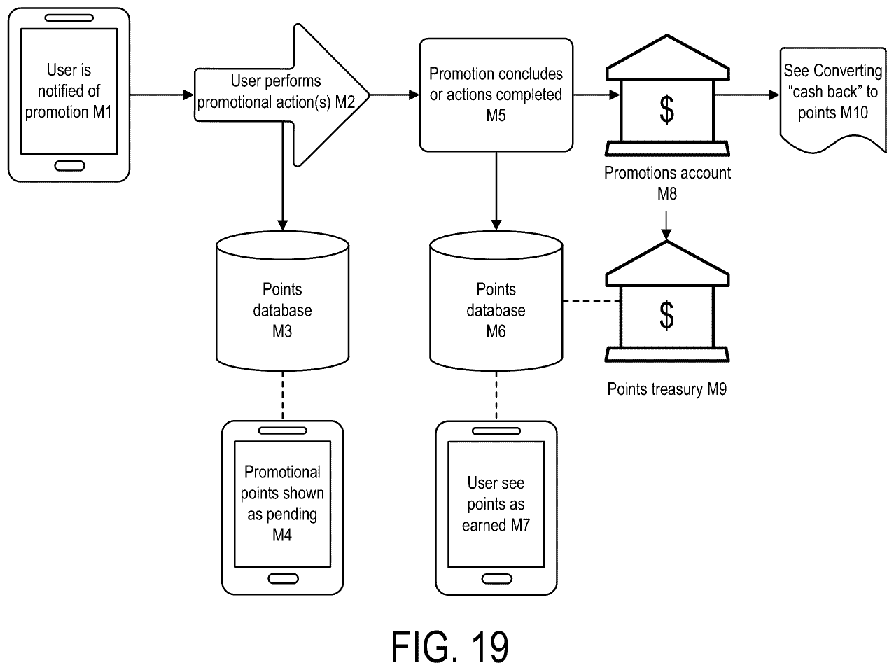

Referring to FIG. 19, the administrative entity may run promotions that allow users to earn points. Users will be notified of these promotions within the app, email, social media or other means M1. As users perform promotional actions M2, the bonus points may be recorded as pending M3. The user may see these points as pending in their app M4. After the promotion concludes, or the user has completed the qualifying actions set forth by the administrative entity, the bonus points may be updated in the database from “pending” to “earned” M6. This may be reflected in the app M7. The money to back these points may be transferred from a promotions budget account M8, to the points treasury M9. This may kickoff the process described above to convert “cash back” to points M10.

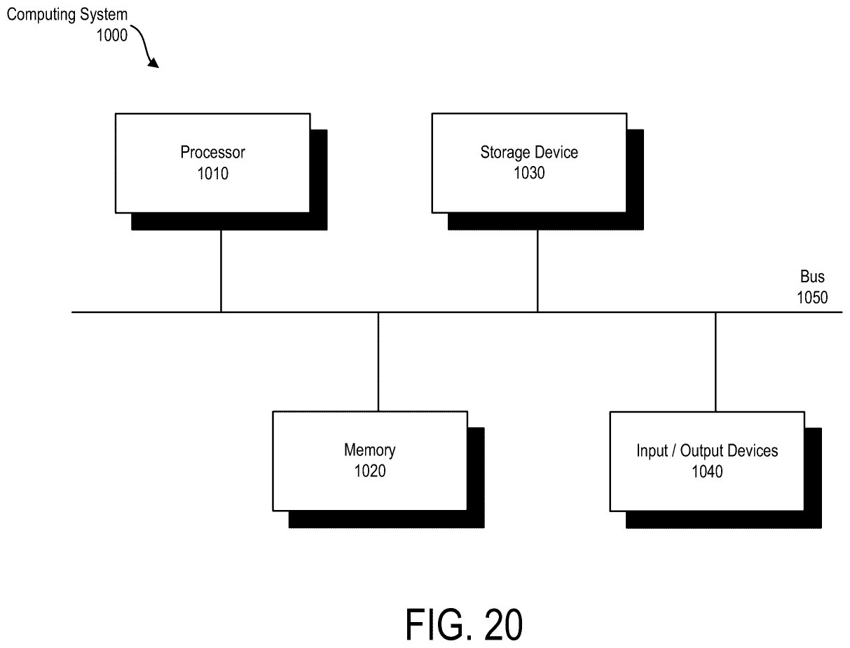

Referring to FIG. 20, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 20, the computing system 1000 may include a processor 1010, a memory 1020, a storage device 1030, and input/output devices 1040. The processor 1010, the memory 1020, the storage device 1030, and the input/output devices 1040 may be interconnected via a system bus 1050. The processor 1010 is capable of processing instructions for execution within the computing system 1000. Such executed instructions may implement one or more components of, for example, a cloud platform. In some implementations of the current subject matter, the processor 1010 may be a single-threaded processor. Alternately, the processor 1010 may be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 may store data structures representing configuration object databases, for example. The storage device 1030 is capable of providing persistent storage for the computing system 1000. The storage device 1030 may be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 may provide input/output operations for a network device. For example, the input/output device 1040 may include Ethernet ports or other networking ports to communicate with one or more wired and/or wireless networks (e.g., a local area network (LAN), a wide area network (WAN), the Internet).

In some implementations of the current subject matter, the computing system 1000 may be used to execute various interactive computer software applications that may be used for organization, analysis and/or storage of data in various (e.g., tabular) format (e.g., Microsoft Excel®, and/or any other type of software). Alternatively, the computing system 1000 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing products and/or functionalities. Upon activation within the applications, the functionalities may be used to generate the user interface provided via the input/output device 1040. The user interface may be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It may also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It may also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It may be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It may be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, may be apparent to those of skill in the art upon reviewing the above description.

The disclosed subject matter has been provided here with reference to one or more features or embodiments. Those skilled in the art may recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A computer-implemented system comprising:
at least one programmable processor; and
a non-transitory machine-readable medium storing instructions that, when executed by the at least one programmable processor, cause the at least one programmable processor to perform operations comprising:
receiving an indication of a booking event completed by a user utilizing an application executed on a computing machine,
the booking event being memorialized by way of storing a booking record in a booking database,
the booking event being associated with a user's balance, the user's balance being represented by a number of points divisible into a first points portion and a second points portion;
generating one or more electronic tokens having a first value equal to a value of the first points portion, in response to a first threshold being met;
storing the one or more electronic tokens in an electronic ledger associated with the user, wherein the user is authorized to utilize the one or more electronic tokens on an electronic exchange platform to obtain one or more items or services; and
maintaining the second points portion as credit on the user's balance, wherein the user is not authorized to use the credit to obtain items or services of value.

2. The system of claim 1, further comprising:
displaying a first value associated with the first points portion in a first area of a user interface of the computing machine;
displaying a second value associated with the second points portion in a second area of a user interface of the computing machine; and
displaying a third value associated with the one or more electronic tokens in a third area of a user interface of the computing machine.

3. The system of claim 2, further comprising:
updating the user's balance including the first points portion and the second points portion, in response to receiving additional indications of booking events completed by the user; and
updating the first points portion, in response to the second points portion exceeding a predetermined threshold.

4. The system of claim 1, wherein the electronic ledger is implemented on a blockchain platform.

5. The system of claim 1, where a smart contract is implemented to mint the one or more electronic tokens to be added to the electronic ledger.

6. The system of claim 1, wherein the one or more electronic tokens are cryptographic tokens.

7. The system of claim 6, wherein the smart contract is an Ethereum ERC-20 smart contract.

8. The system of claim 6, wherein the electronic ledger is implemented over an Ethereum blockchain ecosystem.

9. The system of claim 1, where a smart contract is implemented to mint non-fungible tokens (NFTs) as defined by Ethereum ERC-721 Non-fungible Token Standard.

10. The system of claim 9, wherein the NFTs have unique properties and attributes.

11. A computer-implemented method comprising:
receiving an indication of a booking event completed by a user utilizing an application executed on a computing machine,
the booking event being memorialized by way of storing a booking record in a booking database,
the booking event being associated with a user's balance, the user's balance being represented by a number of points divisible into a first points portion and a second points portion;
generating one or more electronic tokens having a first value equal to a value of the first points portion, in response to a first threshold being met;
storing the one or more electronic tokens in an electronic ledger associated with the user, wherein the user is authorized to utilize the one or more electronic tokens on an electronic exchange platform to obtain one or more items or services; and
maintaining the second points portion as credit on the user's balance, wherein the user is not authorized to use the credit to obtain items or services of value.

12. A computer program product comprising a non-transitory machine-readable medium storing instructions that, when executed by at least one programmable processor, cause the at least one programmable processor to perform operations comprising:
receiving an indication of a booking event completed by a user utilizing an application executed on a computing machine,
the booking event being memorialized by way of storing a booking record in a booking database,
the booking event being associated with a user's balance, the user's balance being represented by a number of points divisible into a first points portion and a second points portion;
generating one or more electronic tokens having a first value equal to a value of the first points portion, in response to a first threshold being met;
storing the one or more electronic tokens in an electronic ledger associated with the user, wherein the user is authorized to utilize the one or more electronic tokens on an electronic exchange platform to obtain one or more items or services; and
maintaining the second points portion as credit on the user's balance, wherein the user is not authorized to use the credit to obtain items or services of value.
